(19) United States
(12) Patent Application Publication
(10) Pub. No.: US 2009/0130451 A1
(43) Pub. Date: May 21, 2009

(54) LASER-WELDABLE THERMOPLASTICS, METHODS OF MANUFACTURE, AND ARTICLES THEREOF

(76) Inventor: Tony Farrell, Bergen op Zoom (NL)

Correspondence Address: CANTOR COLBURN, LLP, 20 Church Street, 22nd Floor, Hartford, CT, 06103, US

(21) Appl. No.: 11/942,405

(22) Filed: Nov. 19, 2007

(51) Int. Cl. B32B 9/00; B29C 65/16; C08L 25/02; C08G 67/00; C08L 25/06; C08G 18/00; C08G 75/20; C08G 63/00; C08L 23/04; C08L 33/04; C08L 9/02; C08K 3/22

(52) U.S. Cl. 428/411.1; 156/272.8; 524/570; 524/612; 524/577; 524/589; 524/609; 524/599; 524/586; 524/556; 524/566; 524/497

(57) ABSTRACT

A laser-weldable composition is disclosed, comprising, based on the total weight of the laser-weldable composition, more than zero to 99.95 weight percent of a thermoplastic polymer composition; from 0.00001 to 5 weight percent of a near-infrared absorbing material; from 0.0 to 0.02 weight percent of carbon black; and from 0.05 to 20 weight percent of a white pigment.

### BACKGROUND

This disclosure relates to laser-weldable thermoplastic compositions, methods of manufacture, and articles thereof.

Near-infrared (NIR) laser-welding of two polymer articles by transmission welding requires one of the polymer articles to be at least partially transparent to laser light, and the other to absorb a significant amount of the laser light. The absorbing polymer heats up in the exposed area, resulting in the melting of both the absorbing and the transmitting polymers, thus generating a weld at the interface.

Thermoplastic polymers are generally transparent to NIR light (herein, radiation wavelengths of 800 to 1400 nanometers). To increase absorption and generate more heat for a given laser exposure, NIR absorbing additives are incorporated in the polymer. The additives include pigments and dyes that also typically absorb visible light (herein, wavelengths of 350 to 800 nanometers) at least to a small degree. This is a drawback for achieving light colored, including white, polymer substrates due to visually detectable and undesirable color shifts caused by even low levels of the NIR absorbing pigments.

White and light colored polymers are typically formed by blending particulate inorganic pigments with a polymer. This leads to the high opacity and bright appearance of polymer blends incorporating these materials. However, such pigments generally possess high reflectivity to both NIR and visible light; that is, they scatter the light away from the surface without absorbing it.

Modifications to existing polymer formulations to improve absorption or transmittance of NIR laser light have increased the available selection of NIR laser-weldable materials. However, there still remains a need to develop opaque, light colored laser absorbing polymer compositions (including white compositions) for use in laser-welding processes.

### SUMMARY

The above described challenges in achieving opaque, light colored and white laser-weldable thermoplastics are overcome according to the several embodiments disclosed herein.

In one embodiment, a laser-weldable composition comprises, based on the total weight of the laser-weldable composition, more than zero to 99.95 weight percent of a thermoplastic polymer composition; from 0.00001 to 5 weight percent of a near-infrared absorbing material; from 0.0 to 0.02 weight percent of carbon black; and from 0.05 to 20 weight percent of a white pigment.

In another embodiment, a method of manufacturing the laser-weldable composition comprises melt blending the components as disclosed herein to form the laser-weldable composition.

An article comprising the laser-weldable compositions is disclosed herein.

A method of manufacture of an article comprises forming, extruding, casting, or molding a melt of the laser-weldable compositions as disclosed herein.

A laser-welded article comprises a first laser-weldable thermoplastic component that is at least partially transmissive to near-infrared radiation wavelengths, and a second laser-weldable component comprising the composition of claim 1, wherein at least a portion of a surface of the first laser-weldable thermoplastic component is laser-welded to at least a portion of a surface of the second laser-weldable component.

In another embodiment, a method of laser-welding thermoplastic components comprises contacting at least a portion of a surface of a first thermoplastic component that is partially transmissive to near-infrared radiation wavelengths, with at least a portion of a surface of a second laser-weldable component comprising the laser-weldable composition as disclosed herein; irradiating with a near-infrared laser through the first thermoplastic component to the second laser-weldable component with an intensity of radiation effective to welding the first thermoplastic component to the second laser-weldable component.

The above described and other features and advantages will become more apparent by reference to the following figures and detailed description.

### BRIEF DESCRIPTION OF THE DRAWING

The FIGURE is a schematic depicting the laser-welding of a near-infrared transmissive component to a near-infrared absorbing component by exposure through the near-infrared transmissive component.

### DETAILED DESCRIPTION

It has surprisingly been found by the inventors hereof that opaque, white and light colored laser-weldable compositions with exceptional weld strengths can be obtained using specific white pigments. The current discovery is based on laser-weldable compositions comprising a thermoplastic polymer composition, a white pigment, and a near-infrared (NIR) absorbing material that absorbs radiation at a wavelength from 800 and 1400 nanometers. The laser-weldable compositions can have a light appearance with comparable and usually much improved weld strengths to those formed with polymer compositions comprising no white pigment. These are performance features that are highly valued by users.

Compounds are described herein using standard nomenclature. The singular forms “a,” “an,” and “the” include plural referents unless the context clearly dictates otherwise. All references are incorporated herein by reference. The term “combination thereof” means that one or more of the listed components is present, optionally together with one or more like components not listed. Other than in the operating examples or where otherwise indicated, all numbers or expressions referring to quantities of ingredients, reaction conditions, and the like, used in the specification and claims are to be understood as modified in all instances by the term “about.” Various numerical ranges are disclosed in this patent application. Because these ranges are continuous, they include every value between the minimum and maximum values. Unless expressly indicated otherwise, the various numerical ranges specified in this application are approximations. The endpoints of all ranges reciting the same characteristic or component are independently combinable and inclusive of the recited endpoint.

Thermoplastic polymer compositions can be used herein are known to those of skill in the art, and can include but are not limited to, olefinic polymers, including polyethylene and its copolymers and terpolymers, polybutylene and its copolymers and terpolymers, polypropylene and its copolymers and terpolymers; alpha-olefin polymers, including linear or substantially linear interpolymers of ethylene and at least one alpha-olefin and atactic poly(alpha-olefins); rubbery block copolymers; polyamides; polyimides; polyesters such as poly(arylates), poly(ethylene terephthalate) and poly(butylene terephthalate); vinylic polymers such as polyvinyl chloride and polyvinyl esters such as polyvinyl acetate; acrylic homopolymers, copolymers and terpolymers; epoxies; polycarbonates, polyester-polycarbonates; polystyrene; poly(arylene ethers), including poly(phenylene ether); polyurethanes; phenoxy resins; polysulfones; polyethers; acetal resins; polyoxyethylenes; and combinations thereof. More particularly, the polymers are selected from the group consisting of polyethylene, ethylene copolymers, polypropylene, propylene copolymers, polyesters, polycarbonates, polyester-polycarbonates, polyamides, poly(arylene ether)s, and combinations thereof.

Olefinic polymers, such as polyethylene, polypropylene and polybutylene, are from a broad class of polymers typically referred to as polymers of ethylenically unsaturated monomers, and the copolymers and terpolymers of such polymers with higher olefins such as alpha-olefins containing 4 to 10 carbon atoms, or vinyl acetate, and the like. Olefins, i.e. ethylene, are often copolymerized with vinyl monomers such as acrylates or vinyl esters of carboxylic acid compounds. Specific acrylate monomers include acrylic acid, methacrylic acid, acrylamide, methacrylamide, methyl acrylate, methyl methacrylate, methoxyethyl methacrylate, methoxyethyl acrylate, and the like. Vinyl esters of carboxylic acids include vinyl acetate, vinyl butyrate, and the like. Commonly used polymers of this variety include, for instance, ethylene vinyl acetate, ethylene ethyl acrylate, ethylene n-butyl acrylate, and ethylene methyl acrylate.

In a specific embodiment, the thermoplastic polymer composition comprises a polymer selected from the group consisting of olefinic polymers, polyamides, polyimides, polystyrene, polyarylene ethers, polyurethanes, phenoxy resins, polysulfones, polyethers, acetal resins, polyesters, vinylic polymers, acrylics, epoxies, polycarbonates, polyester-polycarbonates, styrene-acrylonitrile copolymers and combinations thereof. More specifically, the thermoplastic polymer composition comprises a polymer selected from the group consisting of polycarbonate, polyester, polyamide, and combinations thereof, and still more specifically a combination of a polycarbonate and a polyester.

Suitable polyesters comprise repeating units of formula (1):

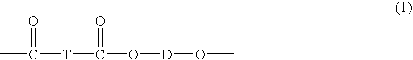

wherein T is a residue derived from a C₈₋₁₂ aromatic or C₅₋₇ cycloaliphatic dicarboxylic acid or chemical equivalent thereof, and D is a residue derived from a C₆₋₁₂ aromatic or a C₂₋₁₂ aliphatic diol or chemical equivalent thereof.

Examples of aromatic dicarboxylic acids that can be used to prepare the polyester units include isophthalic acid, terephthalic acid, 1,4-naphthalenedicarboxylic acid, 1,5-naphthalenedicarboxylic acid, 2,6-naphthalenedicarboxylic acid, and combinations comprising at least one of the foregoing dicarboxylic acids. Exemplary cycloaliphatic dicarboxylic acids include norbornene dicarboxylic acids, 1,4-cyclohexanedicarboxylic acids, and the like. Chemical equivalents of any of the foregoing diacids include dialkyl esters, e.g., dimethyl esters, diaryl esters, anhydrides, salts, acid chlorides, acid bromides, and the like.

Specific dicarboxylic acids are terephthalic acid, isophthalic acid, naphthalene dicarboxylic acid, 1,4-cyclohexane dicarboxylic acid (cis or trans), or a combination comprising at least one of the foregoing dicarboxylic acids. A specific dicarboxylic acid comprises a combination of isophthalic acid and terephthalic acid wherein the weight ratio of isophthalic acid to terephthalic acid is 91:9 to 2:98.

Suitable C₆₋₁₂ aromatic diols include, but are not limited to, resorcinol, hydroquinone, and pyrocatechol, as well as diols such as 1,5-naphthalene diol, 2,6-naphthalene diol, 1,4-napthalene diol, 4,4′-dihydroxybiphenyl, bis(4-hydroxyphenyl) ether, bis(4-hydroxyphenyl) sulfone, and the like, and combinations comprising at least one of the foregoing aromatic diols.

Exemplary C₂₋₁₂ aliphatic diols include, but are not limited to, straight chain, branched, or cycloaliphatic alkane diols such as ethylene glycol, propylene glycol, i.e., 1,2- and 1,3-propylene glycol, 2,2-dimethyl-1,3-propane diol, 2-ethyl-2-methyl-1,3-propane diol, 1,4-butane diol, 1,4-but-2-ene diol, 1,3- and 1,5-pentane diol, dipropylene glycol, 2-methyl-1,5-pentane diol, 1,6-hexane diol, dimethanol decalin, dimethanol bicyclooctane, 1,4-cyclohexane dimethanol, including its cis- and trans-isomers, triethylene glycol, 1,10-decanediol; and combinations comprising at least of the foregoing diols. Chemical equivalents of any of the foregoing diols include esters, such as dialkylesters, diaryl esters, and the like. Specific aliphatic diols are cyclohexane dimethanol, ethylene glycol, or a combination comprising cyclohexanedimethanol and ethylene glycol.

In one embodiment, T is derived from cyclohexanedicarboxylic acid, terephthalic acid, isophthalic acid, a chemical equivalent of any of the foregoing, or a combination comprising at least one of the foregoing, and D is derived from 1,4-cyclohexanedimethanol, a C₂₋₄ diol, a chemical equivalent of the foregoing, or a combination comprising at least one of the foregoing.

A specific class of polyesters within the scope of formula (1) are the poly(cycloalkylene phthalate)s such as, for example, poly(cyclohexanedimethanol terephthalate) (PCT), having recurring units of formula (2)

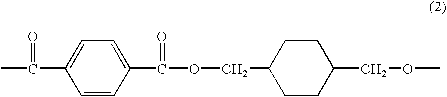

wherein, according to formula (8), T is derived from terephthalic acid, and D is derived from 1,4-cyclohexanedimethanol.

Another specific class of polyesters within the scope of formula (1) is the poly(cycloalkylene cycloalkanoate)s wherein T and D each contain cycloalkyl groups. In one embodiment, T is derived from cyclohexane dicarboxylic acid and D is a divalent group derived from 1,6-hexane diol, dimethanol decalin, dimethanol bicyclooctane, 1,4-cyclohexane dimethanol and its cis- and trans-isomers, 1,10-decane diol, and the like. A particularly advantageous poly(cycloalkylene cycloalkanoate) is poly(cyclohexane-1,4-dimethylene cyclohexane-1,4-dicarboxylate), also referred to as poly(1,4-cyclohexane-dimethanol-1,4-dicarboxylate) (PCCD), having recurring units of formula (3)

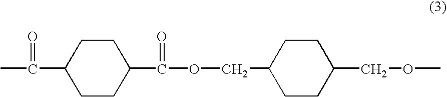

wherein T is derived from 1,4-cyclohexane dicarboxylic acid and D is derived from 1,4-cyclohexanedimethanol.

Other specific polyesters are copolyesters derived from an aromatic dicarboxylic acid and a mixture of linear aliphatic diols in particular ethylene glycol, butylene glycol, poly(ethylene glycol) or poly(butylene glycol), together with cycloaliphatic diols such as 1,4-hexane diol, dimethanol decalin, dimethanol bicyclooctane, 1,4-cyclohexane dimethanol and its cis- and trans-isomers, 1,10-decane diol, and the like. The ester units comprising the linear aliphatic or cycloaliphatic ester units can be present in the polymer chain as individual units, or as blocks of the same type of units. In one embodiment, polyesters of this type are poly(1,4-cyclohexanedimethylene terephthalate)-co-poly(ethylene terephthalate), known as PCTG when greater than 50 mol % of the ester groups are derived from 1,4-cyclohexanedimethylene terephthalate, or PETG when less than 50 mol % of the ester groups are derived from 1,4-cyclohexanedimethylene terephthalate. In one specific embodiment, the poly(1,4-cyclohexanedimethylene terephthalate)-co-poly(ethylene terephthalate) comprises up to 25 mole percent of a residue derived from a C₂₋₄ diol.

The polyesters can be obtained by interfacial polymerization or melt-process condensation as described above, by solution phase condensation, or by transesterification polymerization wherein, for example, a dialkyl ester such as dimethyl terephthalate can be transesterified with ethylene glycol using acid catalysis, to generate poly(ethylene terephthalate). Branched polyester can be used, in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

The polyesters can have an intrinsic viscosity, as determined in chloroform at 25° C., of 0.3 to 2 deciliters per gram, specifically 0.45 to 1.2 deciliters per gram. The polyesters can have a weight average molecular weight of 10,000 to 200,000 Daltons, specifically 20,000 to 100,000 Daltons as measured by gel permeation chromatography.

Suitable polycarbonates comprise repeating structural carbonate units of formula (1):

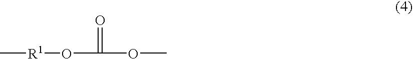

in which at least 60 percent of the total number of R¹ groups contain aromatic organic groups and the balance thereof are aliphatic, alicyclic, or aromatic groups. In an embodiment, each R¹ is a C₆₋₃₀ aromatic group, that is, contains at least one aromatic moiety. R¹ can be derived from a dihydroxy compound of the formula HO—R¹—OH, in particular a dihydroxy compound of formula (5):

HO-A¹-Y¹-A²-OH (5)

wherein each of A¹ and A² is a monocyclic divalent aromatic group and Y¹ is a single bond or a bridging group having one or more atoms that separate A¹ from A². In an exemplary embodiment, one atom separates A¹ from A². Specifically, each R¹ can be derived from a dihydroxy aromatic compound of formula (6)

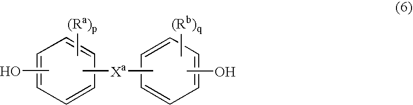

wherein R^{a} and R^{b} each represent a halogen or C₁₋₁₂ alkyl group and can be the same or different; and p and q are each independently integers of 0 to 4. Also in formula (6), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group Xa is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic bridging group can be disposed such that the C₆ arylene groups connected thereto are each connected to a common alkylidene carbon or to different carbons of the C₁₋₁₈ organic bridging group. In one embodiment, p and q is each 1, and R^{a} and R^{b} are each a C₁₋₃ alkyl group, specifically methyl, disposed meta to the hydroxy group on each arylene group.

In an embodiment, X^{a} is a substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene.

Other useful aromatic dihydroxy compounds of the formula HO—R¹—OH include compounds of formula (7)

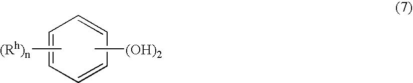

herein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, and the like, as well as combinations comprising at least one of the foregoing dihydroxy compounds.

Specific examples of bisphenol compounds of formula (6) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (6).

Other exemplary polycarbonates include polysiloxane-polycarbonate copolymers that comprise carbonate units of formula (4) and polysiloxane units of formula (6) and/or (7)

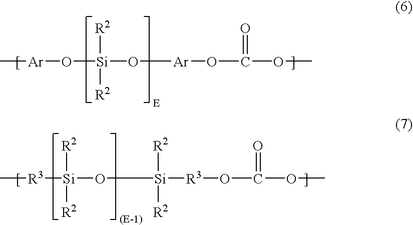

wherein each R² is independently the same or different C₁₋₁₃ monovalent organic group, each Ar is independently the same or different C₆₋₃₆ arylene group wherein the bonds are directly connected to an aromatic moiety, each R³ is independently the same or different divalent C₁₋₃₀ organic group, and E is an integer having an average value of 2 to 1,000.

Specifically R² can be a C₁-C₁₃ alkyl, C₁-C₁₃ alkoxy, C₂-C₁₃ alkenyl, C₂-C₁₃ alkenyloxy, C₃-C₆ cycloalkyl, C₃-C₆ cycloalkoxy, C₆-C₁₄ aryl, C₆-C₁₀ aryloxy, C₇-C₁₃ arylalkyl, C₇-C₁₃ arylalkoxy, C₇-C₁₃ alkylaryl, or C₇-C₁₃ alkylaryloxy. The foregoing groups can be fully or partially halogenated with fluorine, chlorine, bromine, or iodine, or a combination thereof. In an embodiment, where a transparent polysiloxane-polycarbonate is desired, R is unsubstituted by halogen. Combinations of the foregoing R groups can be used in the same copolymer.

The Ar groups in formula (6) can be derived from a C₆-C₃₀ dihydroxyarylene compound, for example a dihydroxyarylene of formula (6) or (7) above. Exemplary dihydroxyarylene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxyphenyl) cyclohexane, bis(4-hydroxyphenyl sulfide), and 1,1-bis(4-hydroxy-t-butylphenyl) propane.

The R³ groups in formula (7) can be a C₁-C₁₃ alkylene, C₃-C₆ cycloalkylene, or C₆-C₁₄ arylene. In one embodiment, each R³ is a group of formula (8)

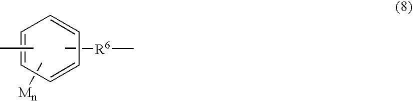

wherein R⁶ is a C₂-C₈ alkylene, each M is the same or different halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ arylalkoxy, C₇-C₁₂ alkylaryl, or C₇-C₁₂ alkylaryloxy, and each n is independently 0, 1, 2, 3, or 4.

The value of E in formulas (6) and (7) can vary widely depending on the type and relative amount of each component in the thermoplastic composition, the desired properties of the composition, and like considerations. Generally, E has an average value of 2 to 1,000, specifically 2 to 500, more specifically 5 to 100. In one embodiment, E has an average value of 10 to 75, and in still another embodiment, E has an average value of 40 to 60. Where E is of a lower value, e.g., less than 40, it can be desirable to use a relatively larger amount of the polycarbonate-polysiloxane copolymer. Conversely, where E is of a higher value, e.g., greater than 40, it can be necessary to use a relatively lower amount of the copolymer.

In a specific embodiment, the polysiloxane units are of formula (7) wherein each R² is independently the same or different C₁₋₃ monovalent organic group, each R³ is the same or different divalent C₁₋₁₀ organic group, and E is an integer from 2 to 500. In a specific embodiment, each R² is the same or different C₁₋₃ alkyl or C₁₋₃ haloalkyl, each R³ is of formula (8) wherein R⁶ is the same C₁₋₅ alkylene and each M is the same and is bromo or chloro, a C₁₋₃ alkyl, C₁₋₃ alkoxy, phenyl, chlorophenyl, or tolyl, and E is an integer having an average value of 4 to 100. In still another embodiment, each R² is methyl, each R³ is of formula (8) wherein R⁶ is trimethylene, M is methoxy, and n is one. Such polycarbonate-siloxane copolymers are sold commercially by Sabic Innovative Plastics.

Polycarbonates can be manufactured by processes such as interfacial polymerization and melt polymerization as are known in the art. The polycarbonates can have a weight average molecular weight of 10,000 to 200,000 Daltons, specifically 20,000 to 100,000 Daltons as measured by gel permeation chromatography (GPC), using a crosslinked styrene-divinylbenzene column and calibrated to polycarbonate references. GPC samples are prepared at a concentration of 1 mg/ml, and are eluted at a flow rate of 1.5 ml/min.

The thermoplastic polymer composition can further comprise a polyester-polycarbonate copolymer. The polyester-polycarbonate copolymer comprises, based on the total weight of the copolymer, 15 to 95 weight percent of arylate ester units, and 5 to 85 weight percent of carbonate units.

The arylate ester units are of formula (9)

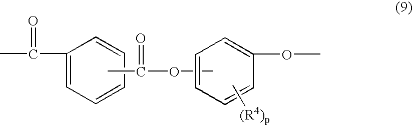

wherein each R⁴ is independently a halogen or a C₁₋₄ alkyl, and p is 0 to 3. The arylate ester units can be derived from the reaction of a mixture of terephthalic acid and isophthalic acid or chemical equivalents thereof with compounds such as 5-methyl resorcinol, 5-ethyl resorcinol, 5-propyl resorcinol, 5-butyl resorcinol, 5-t-butyl resorcinol, 2,4,5-trifluoro resorcinol, 2,4,6-trifluoro resorcinol, 4,5,6-trifluoro resorcinol, 2,4,5-tribromo resorcinol, 2,4,6-tribromo resorcinol, 4,5,6-tribromo resorcinol, catechol, hydroquinone, 2-methyl hydroquinone, 2-ethyl hydroquinone, 2-propyl hydroquinone, 2-butyl hydroquinone, 2-t-butyl hydroquinone, 2,3,5-trimethyl hydroquinone, 2,3,5-tri-t-butyl hydroquinone, 2,3,5-trifluoro hydroquinone, 2,3,5-tribromo hydroquinone, or a combination comprising at least one of the foregoing compounds.

The aromatic carbonate units in the polyester-polycarbonate copolymer are of formula (4) as described above. Specifically, the carbonate units are derived from a dihydroxy compound of formula (6), specifically a compound of formula (6) wherein X^{a} is a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R)— wherein R^{e} is a divalent C₁₋₁₂ hydrocarbon group, even ore specifically Bisphenol A.

In a specific embodiment, the polyester-polycarbonate copolymer is a poly(isophthalate-terephthalate-resorcinol ester)-co-(bisphenol A carbonate) polymer comprising repeating structures of formula (10)

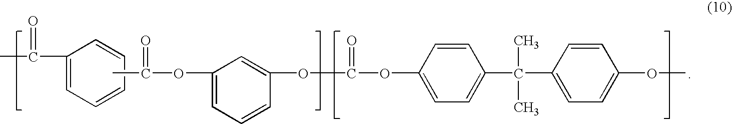

The polyester-polycarbonate copolymer comprises terminal groups derived from the reaction with a chain stopper (also referred to as a capping agent), which limits molecular weight growth rate, and so controls molecular weight in the polycarbonate. The chain stoppers are monophenolic compounds of formula (11)

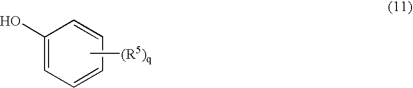

wherein each R⁵ is independently halogen, C₁₋₂₂ alkyl, C₁₋₂₂ alkoxy, C₁₋₂₂ alkoxycarbonyl, C₆₋₁₀ aryl, C₆₋₁₀ aryloxy, C₆₋₁₀ aryloxycarbonyl, C₆₋₁₀ arylcarbonyl, C₇₋₂₂ alkylaryl, C₇₋₂₂ arylalkyl, C₆₋₃₀ 2-benzotriazole, or triazine, and q is 0 to 5. As used herein, C₆₋₁₆ benzotriazole includes unsubstituted and substituted benzotriazoles, wherein the benzotriazoles are substituted with up to three halogen, cyano, C₁₋₈ alkyl, C₁₋₈ alkoxy, C₆₋₁₀ aryl, or C₆₋₁₀ aryloxy groups.

Exemplary monophenolic chain stoppers of formula (11) include phenol, p-cumyl-phenol, p-tertiary-butyl phenol, hydroxy diphenyl, monoethers of hydroquinones such as p-methoxyphenol, alkyl-substituted phenols including those with branched chain alkyl substituents having 8 to 9 carbon atoms, monophenolic UV absorber such as 4-substituted-2-hydroxybenzophenone, aryl salicylate, monoesters of diphenols such as resorcinol monobenzoate, 2-(2-hydroxyaryl)-benzotriazole, 2-(2-hydroxyaryl)-1,3,5-triazines, and the like. Specific monophenolic chain stoppers include phenol, p-cumylphenol, and resorcinol monobenzoate.

Other exemplary chain stoppers include, for example, monocarboxylic acid halides, monohaloformates, and the like. Such chain stoppers can be of formula (11), wherein a —C(O)X or —OC(O)Cl group is present in place of the phenolic hydroxyl group, and X is a halogen, particularly bromine or chloride. Monocarboxylic acid chlorides and monochloroformates can be specifically mentioned. Exemplary monocarboxylic acid chlorides include monocyclic, monocarboxylic acid chlorides such as benzoyl chloride, C₁₋₂₂ alkyl-substituted benzoyl chloride, 4-methylbenzoyl chloride, halogen-substituted benzoyl chloride, bromobenzoyl chloride, cinnamoyl chloride, 4-nadimidobenzoyl chloride, and combinations thereof; polycyclic, monocarboxylic acid chlorides such as trimellitic anhydride chloride, and naphthoyl chloride; and combinations of monocyclic and polycyclic monocarboxylic acid chlorides. Chlorides of aliphatic monocarboxylic acids with up to 22 carbon atoms are suitable. Functionalized chlorides of aliphatic monocarboxylic acids, such as acryloyl chloride and methacryloyl chloride, are also suitable. Monochloroformates include monocyclic monochloroformates, such as phenyl chloroformate, alkyl-substituted phenyl chloroformate, p-cumyl phenyl chloroformate, toluene chloroformate, and combinations thereof. A combination of different chain stoppers can be used, for example a combination of two different monophenolic chain stoppers, or a combination of a monophenolic chain stopper and a monochloroformate chain stopper.

The type and amount of chain stopper used in the manufacture of the polyester-polycarbonate copolymers are selected to provide copolymers having an Mw of 1,500 to 100,000 Daltons, specifically 1,700 to 50,000 Daltons, and more specifically 2,000 to 40,000 Daltons. Molecular weight determinations are performed using gel permeation chromatography, using a crosslinked styrene-divinylbenzene column, and calibrated to bisphenol A polycarbonate references. Samples are prepared at a concentration of 1 milligram per milliliter, and are eluted at a flow rate of 1.0 milliliter per minute.

The thermoplastic polymer component of the laser-weldable compositions can optionally comprise an impact modifier. Exemplary impact modifiers are a natural rubber, low-density polyethylene, high-density polyethylene, polypropylene, polystyrene, polybutadiene, styrene-butadiene, styrene-butadiene-styrene, styrene-ethylene-butadiene-styrene, acrylonitrile-butadiene-styrene, acrylonitrile-ethylene-propylene-diene-styrene, styrene-isoprene-styrene, methyl methacrylate-butadiene-styrene, a styrene-acrylonitrile, an ethylene-propylene copolymer, an ethylene-propylene-diene terpolymer, an ethylene-methyl acrylate copolymer, an ethylene-ethyl acrylate copolymer, an ethylene-vinyl acetate copolymer, an ethylene-glycidyl methacrylate copolymer, a polyethylene terephthalate-poly(tetramethyleneoxide)glycol block copolymer, a polyethylene terephthalate/isophthalate-poly(tetramethyleneoxide)glycol block copolymer, a silicone rubber, or a combination comprising at least one of the foregoing modifiers. A specific impact modifier composition is a combination of methyl methacrylate-butadiene-styrene (MBS) and styrene-acrylonitrile (SAN).

Impact modifiers can be present in an amount of more than 0 to 40 wt. % (weight percent), based on the total weight of the composition. In specific embodiments the impact modifier is present in an amount of 1 to 30 wt. %, specifically 3 to 20 wt. % of the total composition.

In one embodiment the thermoplastic polymer component is present in the laser-weldable composition in an amount of more than zero to 99.5 wt. % and more particularly 30 to 99 wt. %, and even more particularly 80 to 98 wt. %, based on the total weight of the laser-weldable composition. The amount can be varied to achieve the desired weldable and other characteristics of the composition.

In a specific embodiment the thermoplastic polymer composition comprises a polycarbonate, and in another embodiment, the thermoplastic polymer composition a polycarbonate and an impact modifier. For example, the thermoplastic polymer composition can comprise from 50 to 100 wt. % of polycarbonate and from 0 to 50 wt. % of an impact modifier, specifically from 80 to 100 wt. % of a polycarbonate and from 0 to 20 wt. % of an impact modifier, wherein each of the foregoing amounts is based on the total weight of the thermoplastic polymer composition. Optionally, only the polycarbonate is present in the thermoplastic polymer composition, or only the polycarbonate and the impact modifier.

In another embodiment, the thermoplastic polymer composition comprises a combination of a polycarbonate and a polyester, and more specifically a combination of a polycarbonate, a polyester, and an impact modifier. The polycarbonate can comprise units derived from bisphenol A, a poly(butylene terephthalate), and a core-shell polymer type impact modifier, specifically MBS, or a combination of MBS and SAN. In these embodiments, the thermoplastic polymer composition comprises from 10 to 90 wt. %, specifically 40 to 60 wt. % of the polyearbonate, from 10 to 90 wt. %, specifically 40 to 60 wt. % weight percent of the polyester, and from 0 to 40 wt. %, specifically 1 to 20 wt. % of an impact modifier, each based on the total weight of the thermoplastic polymer composition. In one embodiment the thermoplastic polymer composition comprises from 40 to 60 weight percent of the polycarbonate, from 40 to 60 weight percent of the polyester, and from 1 to 20 weight percent of the impact modifier, and further wherein the polycarbonate comprises units derived from bisphenol A, the polyester is poly(butylene terephthalate), and the impact modifier is a core-shell polymer

The laser-weldable polymer composition further comprises a white pigment, for example, titanium dioxide (TiO₂), zinc sulfide (ZnS), tin oxide, aluminum oxide (AlO₃), zinc oxide (ZnO), calcium sulfate, barium sulfate (BaSO₄), calcium carbonate (e.g., chalk), magnesium carbonate, sodium silicate, aluminum silicate, silicon dioxide (SiO₂, i.e., silica), mica, clay, talc, metal doped versions of the foregoing materials, and combinations comprising at least one of the foregoing materials. More particularly, the inorganic white pigment is selected from rutile or anatase titanium dioxide, zinc sulfide, and coated versions thereof such as silanized titanium dioxide. A combination of different types of white pigment can be used. The white pigment has an average particle size of 0.01 to 10 micrometers, specifically 0.05 to 1 micrometer, and more particularly 0.1 to 0.6 micrometers.

In one embodiment the white pigment is titanium dioxide having an particle diameter of 0.01 to 10 micrometers. In still another embodiment, the white pigment is titanium dioxide having an average particle diameter from 0.1 to 0.6 micrometers.

In another embodiment the white pigment is zinc sulfide having an average particle diameter from 0.01 to 10 micrometers. In another embodiment the white pigment is zinc sulfide having an average particle diameter from 0.1 to 0.6 micrometers.

In one embodiment the laser-weldable composition consists of no white pigments other than titanium dioxide, zinc sulfide, or combinations thereof. In another embodiment the laser-weldable composition has no barium sulfate, mica, talc, or carbon black.

The white pigment is present in the laser-weldable composition in an amount from 0.05 to 20 wt. %, and more particularly 0.1 to 15 wt. %, and even more particularly 0.5 to 10 wt. %, based on total weight of the laser-weldable composition.

The laser-weldable composition further comprises a near-infrared absorbing material (a material absorbing radiation wavelengths from 800 to 1400 nanometers) that is also not highly absorbing to visible light (radiation wavelengths from 350 nanometers to 800 nanometers). In particular the near-infrared absorbing material can be selected from organic dyes including polycyclic organic compounds such as perylenes, nanoscaled compounds metal complexes including metal oxides, mixed metal oxides, complex oxides, metal-sulphides, metal-borides, metal-phosphates, metal-carbonates, metal-sulphates, metal-nitrides, lanthanum hexaboride, cesium tungsten oxide, indium tin oxide, antimony tin oxide, indium zinc oxide, and combinations thereof. In one embodiment, the near-infrared material has an average particle size of 1 to 200 nanometers.

Depending on the particular NIR absorbing material used, the NIR absorbing material can be present in the laser-weldable composition in an amount from 0.00001 to 5 wt. % of the composition. Suitable amounts provide effective NIR absorption, and are readily determined by one of ordinary skill in the art without undue experimentation. Lanthanum hexaboride and cesium tungsten oxide, for example, are present in the composition in an amount from 0.00001 to 1 wt. %, still more specifically 0.00005 to 0.1 wt. %, and most specifically 0.0001 to 0.01 wt. %, based on total weight of the laser-weldable composition. In one embodiment, the NIR absorbing material can conveniently be predispersed in a small portion of a thermoplastic polymer and the predispersed component can be added to the composition. For example, the NIR absorbing material can be premixed with polycarbonate to provide a composition containing 0.01 to 5% of the NIR absorbing material, and this composition then added to the remaining components. Alternatively, the NIR absorbing material can be compounded or extruded and the compounded/extruded component can be added to the composition. Alternatively, the NIR absorbing material can be added to the composition without compounding or extruding the NIR absorbing material.

The laser-weldable composition can include various other additives ordinarily incorporated with compositions of this type, with the proviso that the additives are selected so as not to significantly adversely affect the desired properties of the composition. Combinations of additives can be used.

Suitable additives include an antioxidant, a thermal stabilizer, a light stabilizer, an ultraviolet light absorbing additive, a quencher, a plasticizer, a lubricant, a mold release agent, an antistatic agent, a filler, a flame retardant, an anti-drip agent, a radiation stabilizer, a mold release agent, or a combination thereof. Each of the foregoing additives, when present, is used in amounts typical for thermoplastic blends, for example, 0.001 to 15 wt. % of the total weight of the blend, specifically 0.01 to 5 wt. % of the total weight of the blend, except for flame retardants, which are more typically used in amounts of 1 to 10 wt. %, based on the total weight of the composition, and fillers. Fillers such as glass fibers are present in an amount from more than zero to 50 wt. % of the total composition, specifically 15 to 30 wt. %.

In one embodiment the laser-weldable composition comprises from 0.1 to 5 weight percent of a thermal stabilizer, an antioxidant, and a quencher, each based on the total weight of the laser-weldable composition. In another embodiment, no filler is present.

Exemplary antioxidant additives include, for example, organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetralkis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Antioxidants can be used in amounts of 0.0001 to 1 weight percent, based on the total weight of the composition.

Exemplary heat stabilizer additives include, for example, organophosphites such as triphenyl phosphite, tris-(2,6-dimethylphenyl)phosphite, tris-(mixed mono-and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers can be used in amounts of 0.0001 to 1 weight percent, based on the total weight of the composition.

Exemplary light stabilizers and/or ultraviolet light (UV) absorbing additives include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers can be used in amounts of 0.0001 to 1 weight percent, based on the total weight of the composition.

Exemplary UV absorbing additives include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB® 5411); 2-hydroxy-4-n-octyloxybenzophenone (CYASORB® 531); 2-[4,6-bis(2,4-dimethylphenyl)-1,3,5-triazin-2-yl]-5-(octyloxy)-phenol (CYASORB® 1164); 2,2′-(1,4-phenylene)bis(4H-3,1-benzoxazin-4-one) (CYASORB® UV-3638); 1,3-bis[(2-cyano-3,3-diphenylacryloyl)oxy]-2,2-bis[[(2-cyano-3,3-diphenylacryloyl)oxy]methyl]propane (UVINUL® 3030); 2,2′-(1,4-phenylene) bis(4H-3,1-benzoxazin-4-one); 1,3-bis[(2-cyano-3,3-diphenylacryloyl)oxy]-2,2-bis[[(2-cyano-3,3-diphenylacryloyl)oxy]methyl]propane; nano-size inorganic materials such as titanium oxide, cerium oxide, and zinc oxide, all with particle size less than 100 nanometers; or the like, or combinations comprising at least one of the foregoing UV absorbers. UV absorbers can be used in amounts of 0.0001 to 1 weight percent, based on the total weight of the composition.

Plasticizers, lubricants, and/or mold release agents additives can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate, the bis(diphenyl) phosphate of hydroquinone and the bis(diphenyl) phosphate of bisphenol-A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate, and the like; combinations of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials can be used in amounts of 0.001 to 1 weight percent, specifically 0.01 to 0.75 weight percent, and more specifically 0.1 to 0.5 weight percent, based on the total weight of the composition.

Inorganic flame retardants can also be used, for example salts of C₂₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complexes such as Li₃AlF₆, BaSiF₆, KBF₄, K₃AlF₆, KAlF₄, K₂SiF₆ and/or Na₃AlF₆ or the like. When present, inorganic flame retardant salts can be present in amounts of 0.1 to 5 weight percent, based on the total weight of the composition.

Organic flame retardants that can be used include various phosphorus-containing compounds, in particular aromatic phosphorus-containing compounds and brominated or chlorinated organic compounds. Organic compounds containing phosphorus-nitrogen bonds can be used, as well compounds such as phosphonate, phosphinate, phosphite, phosphine oxide, and phosphate esters can be used, for example triethyl phosphate, triphenyl phosphate, tris(dichloropropyl) phosphate; tris(2-chloroethyl)phosphate; tris(dibromopropyl) phosphate; tris(bromochloropropyl)phosphate; and the like. Brominated organic compounds contain bromine atoms directly bonded to an organic moiety, for example an aromatic or cycloaliphatic ring, for example compounds derived from brominated Bisphenol A, tetrabromophthalic anhydride, and the like, and pentabromocyclohexane, pentabromochlorocyclohexane, hexabromocyclohexane, 1,2-dibromo-4-(1,2-dibromoethyl)-cyclohexane, tetrabromocyclooctane, hexabromocyclooctane, hexabromocyclododecane, chloroparaffins, and analogous bromine- or chlorine-containing aliphatic or cycloaliphatic compounds.

Suitable quenchers include inorganic acids such as mono zinc phosphate or organic acids, for example phosphoric acid.

The laser-weldable composition can be manufactured by methods generally available in the art. For example, one method of manufacturing a laser-weldable composition comprises melt blending the thermoplastic polymer composition, white pigment, NIR absorbing material to form the laser-weldable composition. More particularly, the powdered thermoplastic polymer composition, white pigment, NIR absorbing material and other optional additives (including stabilizer packages, e.g., antioxidants, gamma stabilizers, heat stabilizers, ultraviolet light stabilizers, and the like) are first blended, in a HENSCHEL-Mixer® high speed mixer. Other low shear processes such as hand mixing can also accomplish this blending. The blend is then fed into the throat of an extruder via a hopper. Alternatively, one or more of the components can be incorporated into the composition by feeding directly into the extruder at the throat and/or downstream through a sidestuffer. Alternatively, any desired additives can also be compounded into a masterbatch, in particular the white pigment, and combined with the remaining polymeric components at any point in the process. The extruder is generally operated at a temperature higher than that necessary to cause the composition to flow. The extrudate is immediately quenched in a water batch and pelletized. Such pellets can be used for subsequent molding, shaping, or forming. In specific embodiments, a method of manufacturing a laser-weldable composition comprises melt any of the above-described compositions to form the laser-weldable composition.

Shaped, formed, or molded articles comprising the compositions are also provided. In one embodiment, an article is formed by extruding, casting, blow molding, or injection molding a melt of the laser-weldable composition. The article can be in the form of a film or sheet. In specific embodiments, shaped, formed, or molded articles comprising any of the above-described compositions are disclosed.

In another specific embodiment, a laser-weldable composition and article formed therefrom comprises, based on the total weight of the laser-weldable composition, from 75 to 99.5 weight percent of the thermoplastic polymer composition, wherein the thermoplastic polymer composition comprises a polycarbonate, a polyester, or a combination thereof; from 0.0001 to 1 weight percent of the near-infrared material; and from 0.5 to 5 weight percent of the white pigment, wherein the white pigment is selected from particulate titanium dioxide, zinc sulfide, and a combination thereof, each wherein the laser-weldable composition comprises no other white pigment.

In another specific embodiment, a laser-weldable composition and article formed therefrom comprises, based on the total weight of the laser-weldable composition, from 75 to 99.5 weight percent of the thermoplastic polymer composition, wherein the thermoplastic polymer composition comprises a polycarbonate having units derived from bisphenol A, a poly(butylene terephthalate), and a methacrylate-styrene-butadiene impact modifier; from 0.0001 to 0.5 weight percent of the near-infrared material, wherein the near-infrared material comprises lanthanum hexaboride, cesium tungsten oxide, or a combination thereof; and from 0.5 to 5 weight percent of the white pigment, wherein the white pigment is selected from particulate titanium dioxide, zinc sulfide, and a combination thereof, each wherein the laser-weldable composition comprises no other white pigment.

Also disclosed are laser-welded articles comprising a first thermoplastic component that is transmissive to near-infrared radiation wavelengths, and a second laser-weldable component comprising the laser-weldable compositions disclosed herein, wherein at least a portion of a surface of the first thermoplastic component is laser-welded to at least a portion of a surface of the second laser-weldable component. The laser-welded article has a tensile shear strength between the first thermoplastic component and the second laser-weldable component that can range from 10 N/mm² to 50 N/mm², determined in accordance with a tensile shear test at a speed of 5 mm/minute. In one embodiment the laser-welded article has a tensile shear strength between the first thermoplastic component and the second laser-weldable component that is greater than 15 N/mm², determined in accordance with the tensile shear test described herein. In one embodiment the laser-welded article has a tensile shear strength between the first thermoplastic component and the second laser-weldable component that is greater than 20 N/mm², determined in accordance with the tensile shear test described herein.

In a specific embodiment, a laser-welded article is disclosed, wherein the second laser-weldable component comprises: from 75 to 99 weight percent of the thermoplastic polymer composition, wherein the thermoplastic polymer composition comprises a polycarbonate having units derived from bisphenol A, a poly(butylene terephthalate), and a methacrylate-styrene-butadiene impact modifier; from 0.0001 to 1 weight percent of the near-infrared material, wherein the near-infrared material is lanthanum hexaboride, cesium tungsten oxide, or a combination thereof; and from 0.5 to 5 weight percent of the white pigment, wherein the white pigment is a titanium dioxide pigment, and wherein the second laser-weldable component comprises no other white pigment; and herein the tensile shear strength between the first thermoplastic component and the second laser-weldable component is greater than 15 N/mm², determined in accordance with a tensile shear test at a speed of 5 mm/minute.

Also disclosed is a method of laser-welding thermoplastic components comprising contacting at least a portion of a surface of a first laser-weldable thermoplastic component that is at least partially transmissive to near -infrared radiation wavelengths, with at least a portion of a surface of a second laser-weldable component comprising the laser-weldable composition of claim 1, irradiating with a near-infrared laser through the first thermoplastic component to the second plastic laser-weldable component with an intensity of radiation effective to welding the first thermoplastic component to the second laser-weldable component.

The above described process is illustrated generally in the FIGURE for article 10. The first thermoplastic component 12 comprises any thermoplastic polymer composition known in the art as long as it is at least partially transmissive to near-infrared light. Laser exposure 14 is directed through the first thermoplastic component 12 to a second laser-weldable component 16, where laser exposure 14 is absorbed resulting in the formation of heat at interface 18 of the two layers. The heating generates a local melt pool 20 between the layers resulting in a weld of first thermoplastic component 12 to second laser-weldable component 16. The laser exposure 12 generally follows a linear path of overlapping spot exposures to produce a weld seam 22.

The invention is further illustrated by the following non-limiting examples.

### EXAMPLES

### Materials

The materials shown in Table A were used in the Examples below.

TABLE A

| Designation | Description/Trade Name | Source |
|---|---|---|
| PBT-1 | Poly(1,4-butylene terephthalate), | Sabic |
| | intrinsic viscosity (IV) = 1.2 cm³/g, | |
| | measured in a 60:40 phenol/tetrachloroethane | |
| PC-1 | Bisphenol A polycarbonate, MVR = 20.9 | Sabic |
| | (300° C./1.2 kg) | |
| PBT-2 | Poly(1,4-butylene terephthalate), | Sabic |
| | intrinsic viscosity (IV) = 0.66 cm³/g, | |
| | measured in a 60:40 phenol/tetrachloroethane | |
| PC-2 | Bisphenol A polycarbonate, MVR = 5.9 | General Electric |
| | (300° C./1.2 kg) | |
| MBS | Methyl methacrylate-butadiene- | Rohm &Haas |
| | styrene polymer | |
| ABS Resin | 51.8% butadiene, 36.9% styrene, | Sabic |
| | 11.3% acrylonitrile; MFI = 13.5 | |
| | (220° C., 10 kg) | |
| Poly-SAN-2 | 34% acrylonitrile, 66% styrene; | Sabic |
| | MVR = 4.5 (230° C., 1.2 kg) | |
| PE | Poly(ethylene), low density | Sabic |
| AO 1010 | IRGANOX ™ 1010 | Ciba Geigy |
| UVA 5411 | TINUVIN ™ 329 | Ciba Speciality |
| | | Chemicals |
| H₃PO₃ | Phosphorous acid | Quaron |
| PELTP | SEENOX ™ 412 | Clariant |
| UVA 327 | TINUVIN ™ 327 | Ciba Speciality |
| | | Chemicals |
| HALS 770 | TINUVIN ™ 770 | Ciba Speciality |
| | | Chemicals |
| Silicon oil premix | TAG63/Silicon oil 87/13 | SPECHIM SA |
| 87/13 | | |
| EBS wax | UNIWAX ™ 1760 EBS | Uniqema |
| PEPG | PLURIOL PE ™ 8800 | BASF |
| Magnesium oxide | REMAG ™ AC | Spaeter C. GmbH |
| Palmitic/stearic acid | LOXIOL ™ EP8578 | Cognis |
| ester of | | |
| dipenta/pentaerythritol | | |
| Tris(di-t- | IRGAFOS ™ 168 | Ciba Speciality |
| butylphenyl)phosphite | | Chemicals |
| Sodium | ATMER ™ 191 | Croda |
| alkylsulphonate | | |
| TiO₂ | KRONOS ™ 2450 | Kronos |
| | KRONOS ™ 3000 | Kronos |
| | KRONOS ™ 3025 | Kronos |
| | UV-TITAN ™ P580 | Keyser &Mackay |
| PC-LaB₆ | KHCS-06 ™ pigment dispersion | Alconix Europe |
| | | GmbH |
| PC-CTO | YMCS-06 ™ pigment dispersion | Alconix Europe |
| | | GmbH |
| Laserflair ™ 825 | Iriodin ™ LS 825 | Merck &Co. |
| Pigment Brown 24 | Sicotan Yellow K2001FG | BASF |
| Pigment Red 101 | BAYFERROX ™ 140 MPL | Lanxess |
| Pigment Blue 29 | ULTRAMARINE ™ BLUE 51 | Holliday |
| Solvent Red 135 | MACROLEX ™ Red EG | Lanxess |
| Solvent Yellow 163 | ORACET ™ Yellow GHS | Ciba Speciality |
| | | Chemicals |

### Techniques and Procedures

The near infra-red (NIR) transmission and reflection data was collected on a Hitachi U-3410 or a Perkin-Elmer Lambda 950 spectrophotometer at 1064 nm. The thickness of the parts measured is given in the Tables

For welding, high gloss surface 60 mm×60 mm×1.6 mm test pieces 16 were placed together with the corresponding high gloss surface part 12 as in the FIGURE. For the parts shown in Tables A, B, C this was LEXAN® EXL1414T-NA8A005T while for the compositions in table D this was LEXANS 103R-111. The overlapped area was then irradiated with a diode laser (960 nm) with a beam diameter of 2 mm. The power and scanning speeds are shown in the tables.

The laser-welded test pieces were sawn into strips having, e.g., a width of 15 mm or 20 mm, and the tensile strength of the weld was determined by clamping the test pieces and applying a force across the welded area at a rate of 5 mm/minute using a tensile tester (Lloyd draw bench: LR30K). The weld strength is calculated as the maximum load at break divided by the area of the weld, which is calculated as the width of the weld (laser beam width) times the length of the weld (15 mm or 20 mm for example).

The NIR absorbing materials, lanthanum hexaboride (LaB₆) and cesium tungsten oxide (CTO), were each supplied as single dispersions in polycarbonate at a loading of 0.25 wt % of the dispersion. The primary particle size (as determined by X-ray) of the LaB₆ and CTO was 20 nanometers. These particles formed loose agglomerates of up to 120 nanometers in PC.

PC/PBT samples were prepared by melt extrusion on a Werner & Pfleiderer 25 mm twin screw extruder, using a nominal melt temperature of 250 to 275° C., 25 inches (635 mm) of mercury vacuum and 450 rpm. The extrudate was pelletized and dried at 100° C. for 3 hours.

ABS samples were prepared by melt extrusion on a Werner & Pfleiderer 25 mm twin screw extruder, using a nominal melt temperature of 220 to 260° C., 25 inches (635 mm) of mercury vacuum and 450 rpm. The extrudate was pelletized and dried at 90° C. for 3 hours.

PC samples were prepared by melt extrusion on a Werner & Pfleiderer 25 mm twin screw extruder, using a nominal melt temperature of 290 to 320° C., 25 inches (635 mm) of mercury vacuum and 450 rpm. The extrudate was pelletized and dried at 120° C. for 3 hours.

Test specimens 16 were produced from the dried pellets and were injection molded at nominal temperatures of 250 to 290° C. for PC/PBT, 250 to 290° C. for ABS samples, and 290 to 320° C. for PC samples to form specimens for most of the tests below.

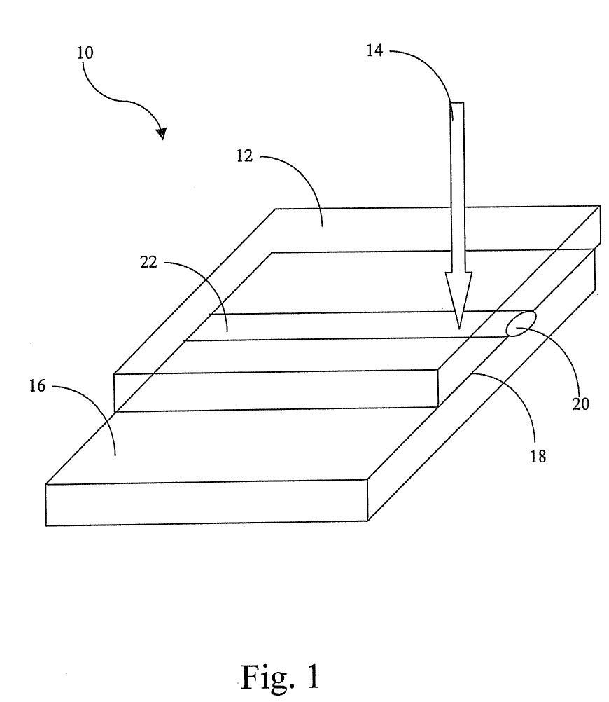

Moreover, test samples 12 (FIG. 1) of dimensions 6 mm×6 mm×2.5 mm to be welded to the test pieces 16 were produced from Lexan EXL1414T-NA8A005T and Lexan 103R-111 were produced according to the datasheet.

### Results

Compositions were formulated in accordance with Tables 1 2, 3, and 4. All amounts are in weight percent, based on the total weight of the compositions.

TABLE 1

| Component | CEx 1 | CEx 2 | Ex 1 | Ex 2 | Ex 3 | Ex 4 | Ex 5 | CEx 3 | Ex 6 |
|---|---|---|---|---|---|---|---|---|---|
| PBT-1 | 30.6 | 30.6 | 30.6 | 30.6 | 30.6 | 30.6 | 30.6 | 30.6 | 30.6 |
| PC-1 | 10.7 | 10.7 | 10.7 | 10.7 | 10.7 | 10.7 | 10.7 | 10.7 | 10.7 |
| PBT-2 | 9.23 | 9.23 | 9.23 | 9.23 | 9.23 | 9.23 | 9.23 | 9.23 | 9.23 |
| MBS | 7 | 7 | 7 | 7 | 7 | 7 | 7 | 7 | 7 |
| PE | 2 | 2 | 2 | 2 | 2 | 2 | 2 | 2 | 2 |
| AO 1010 | 0.08 | 0.08 | 0.08 | 0.08 | 0.08 | 0.08 | 0.08 | 0.08 | 0.08 |
| UVA 5411 | 0.25 | 0.25 | 0.25 | 0.25 | 0.25 | 0.25 | 0.25 | 0.25 | 0.25 |
| H₃PO₃ | 0.08 | 0.08 | 0.08 | 0.08 | 0.08 | 0.08 | 0.08 | 0.08 | 0.08 |
| PELTP | 0.08 | 0.08 | 0.08 | 0.08 | 0.08 | 0.08 | 0.08 | 0.08 | 0.08 |
| TiO₂^{a} | — | | 0.5 | 1.2 | 1.8 | 2.5 | 5.0 | — | 2.5 |
| PC-LaB₆ | — | 0.5 | 0.5 | 0.5 | 0.5 | 0.5 | 0.5 | — | — |
| PC-2 | 40.0 | 39.5 | 38.9 | 38.3 | 37.7 | 37.0 | 34.5 | 39.5 | 37.0 |
| LS 825 | 0 | 0 | 0 | 0 | 0 | 0 | 0 | 0.5 | 0.5 |
| Transmission | 69.3 | 58.0 | 15.5 | 8.0 | 4.7 | 3.1 | 1.4 | 47.2 | 17.0 |
| at 1064 nm^{b} | | | | | | | | | |
| Reflection | 22.0 | 15.9 | 41.1 | 47.8 | 54.0 | 68.4 | 71.2 | 2.4 | 56.8 |
| at 1064 nm^{b} | | | | | | | | | |
| Weld rate | | 15 | 15 | 15 | 15 | 15 | 15 | 20 | 20 |
| (mm/min) | | | | | | | | | |
| Laser power | | 130 | 130 | 130 | 130 | 115 | 125 | 80 | 80 |
| (W) | | | | | | | | | |
| Weld | n.w. | 25.3 | 26.6 | 27.6 | 28.8 | 31.5 | 32.5 | 18.9 | 25.3 |
| strength | | | | | | | | | |
| (N/mm²) | | | | | | | | | |

^{a}KRONOS 2450 (d50m = 0.31 micrometers);
^{b}1.0 mm thick parts, measured using a Hitachi U-3410;
^{c}not weldable.

### Discussion

The beneficial effects of the inventive compositions are evidenced by Examples 1-6. Laser-welding was unsuccessful when test piece 16 was chosen from CEx 1 without a NIR absorbing additive. A comparison of CEx2 with Examples 1-5 and of CEx3 with Example 6 demonstrates that the addition of pigments such as TiO₂ increases the amount of optical scattering in the NIR. However, laser-welded articles based on Examples 1-6 had excellent tensile strength indicating a stronger weld compared to the control samples lacking white pigment.

TABLE 2

| Component | Ex 7 | Ex 8 | Ex 9 | Ex 10 | Ex 11 | Ex 12 |
|---|---|---|---|---|---|---|
| PBT-1 | 30.6 | 30.6 | 30.6 | 30.6 | 30.6 | 30.6 |
| PC-1 | 10.7 | 10.7 | 10.7 | 10.7 | 10.7 | 10.7 |
| PBT-2 | 9.23 | 9.23 | 9.23 | 9.23 | 9.23 | 9.23 |
| MBS | 7 | 7 | 7 | 7 | 7 | 7 |
| PE | 2 | 2 | 2 | 2 | 2 | 2 |
| AO 1010 | 0.08 | 0.08 | 0.08 | 0.08 | 0.08 | 0.08 |
| UVA 5411 | 0.25 | 0.25 | 0.25 | 0.25 | 0.25 | 0.25 |
| H₃PO₃ | 0.08 | 0.08 | 0.08 | 0.08 | 0.08 | 0.08 |
| PELTP | 0.08 | 0.08 | 0.08 | 0.08 | 0.08 | 0.08 |
| TiO₂ | 2.5^{a} | 2.5^{b} | 2.5^{c} | 2.5^{d} | — | — |
| ZnS | — | — | — | — | 2.5 | — |
| BaSO₄ | | | | | | 2.5 |
| PC LaB₆ | 0.5 | 0.5 | 0.5 | | | |
| PC CTO | | | | 1.0 | 1.0 | 1.0 |
| PC-2 | 38.88 | 38.28 | 37.68 | 36.98 | 34.48 | 39.48 |
| Transmission | 19.5 | 3.9 | 5.2 | 1.4 | 17.8 | 37.6 |
| at 1064 nm^{(e)} | | | | | | |
| Reflection at | 35.0 | 58.2 | 49.3 | 52.0 | 41.5 | 10.8 |
| 1064 nm^{(e)} | | | | | | |
| Weld rate | 25 | 15 | 25 | 15 | 15 | 25 |
| (mm/min) | | | | | | |
| Laser power | 130 | 115 | 100 | 90 | 70 | 120 |
| (W) | | | | | | |
| Weld | 26.9 | 29.8 | 26.4 | 25.1 | 22.2 | 20.2 |
| strength | | | | | | |
| (N/mm2) | | | | | | |

^{a}UV-titan P580 (d50m = 0.03 micrometers);
^{b}KRONOS 3000 (d50m = 0.58 micrometers);
^{c}KRONOS 3025 (d50m = 4.35 micrometers);
^{d}KRONOS 2450
^{(e)}1.0 mm thick parts, measured using a Hitachi U-3410.

### Discussion

Comparing Example 4 in Table 1 with Examples 7-9 in Table 2, it is evident that the particle size of titanium dioxide affects the tensile strength of the weld. A comparison of Examples 10-12 also shows that the type of white pigment used affects the tensile strength of the weld.

TABLE 3

| Component | CEx4 | Ex13 | Ex14 |
|---|---|---|---|
| Poly-SAN-2 | 31.47 | 31.36 | 31.27 |
| Pigment Blue 29 | 0.015 | 0.015 | 0.015 |
| Pigment Brown 24 | 0.010 | 0.010 | 0.010 |
| Pigment Red 101 | 0.008 | 0.008 | 0.008 |
| TiO₂^{a} | 7.85 | 7.85 | 7.85 |
| PC LaB₆ | 0 | 0.44 | 0.87 |
| Tris(di-t- | 0.44 | 0.44 | 0.44 |
| butylphenyl)phosphite | | | |
| UVA 327 | 0.22 | 0.22 | 0.22 |
| HALS 770 | 0.22 | 0.22 | 0.22 |
| Na-alkylsulphonate | 0.44 | 0.44 | 0.43 |
| Silicon oil premix 87/13 | 0.61 | 0.61 | 0.61 |
| EBS wax | 1.74 | 1.75 | 1.73 |
| PEPG | 0.87 | 0.87 | 0.87 |
| MgO | 0.09 | 0.09 | 0.09 |
| ABS Resin 360 | 27.99 | 27.87 | 27.74 |
| Poly-SAN 2548 | 27.99 | 27.87 | 27.74 |
| Transmission at 1064 nm^{b} | 5.9 | 0.0 | 0.0 |
| Reflection at 1064 nm^{b} | 92.4 | 81.7 | 66.8 |
| Weld rate (mm/min) | 20 | 20 | 20 |
| Laser power (W) | 80 | 80 | 80 |
| Weld strength (N/mm²) | n.w.^{c} | 17.7 | 19.1 |

^{a}KRONOS 2450 (d50m = 0.31 micrometers);
^{b}1.0 mm thick parts, measured using a Hitachi U-3410;
^{c}Not weldable.

### Discussion

The results in Table 3 show that the beneficial effects of the compositions is retained in different thermoplastic compositions (compare CEx 4 with Examples 13-14.)

TABLE 4

| Component | CEx 5 | Ex 15 | Ex 16 | Ex 17 | Ex 18 |
|---|---|---|---|---|---|
| PC-2 | 98.4 | 97.8 | 95.9 | 96.7 | 96.7 |
| UVA 5411 | 0.15 | 0.15 | 0.15 | 0.15 | 0.15 |
| IRGAFOS ™ 168 | 0.05 | 0.05 | 0.05 | 0.05 | 0.05 |
| LOXIOL ™ EP8578 | 0.4 | 0.4 | 0.4 | 0.4 | 0.4 |
| TiO₂^{a} | | 1.2 | 2.5 | 1.0 | 1.0 |
| PC CTO | 1 | 1 | 1 | | |
| PC LaB₆ | | | | 1 | 1 |
| Solvent Red 135 | | | | 0.5 | 0.5 |
| Solvent Yellow 163 | | | | 0.2 | 0.5 |
| Carbon black | | | | | 0.003 |
| Transmission at 1064 nm^{(b)} | 31.6 | 1.9 | 0.3 | 0.6 | 0.5 |
| Reflection at 1064 nm^{b} | 8.0 | 45.1 | 55.9 | 32.4 | 31.6 |
| Weld rate (mm/min) | 20 | 20 | 20 | 20 | 20 |
| Laser power (W) | 80 | 80 | 80 | 80 | 80 |
| Weld strength (N/mm²) | 19.8 | 27.6 | 31.4 | 25.8 | 26.3 |

^{a}KRONOS ™ 2450;
^{(b)}measured on 1.6 mm plaques using a Perkin-Elmer Lambda 950.

### Discussion

The beneficial effects of the compositions in different thermoplastic compositions are evidenced by comparing CEx 5 with Examples 15-16. Laser-welded articles based on Examples 15-16 show that addition of TiO₂ increases the amount of optical scattering in the NIR, but nonetheless that the tensile shear strength of the weld has increased.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A laser-weldable composition comprising, based on the total weight of the laser-weldable composition,
more than zero to 99.95 weight percent of a thermoplastic polymer composition;
from 0.00001 to 5 weight percent of a near-infrared absorbing material;
from 0.0 to 0.02 weight percent of carbon black; and
from 0.05 to 20 weight percent of a white pigment.

2. The laser-weldable composition of claim 1, wherein the thermoplastic polymer composition comprises a polymer selected from the group consisting of olefinic polymers, polyamides, polyimides, polystyrene, polyarylene ethers, polyurethanes, phenoxy resins, polysulfones, polyethers, acetal resins, polyesters, vinylic polymers, acrylics, epoxies, polycarbonates, polyester-polycarbonates, styrene-acrylonitrile copolymers and combinations thereof.

3. The laser-weldable composition of claim 1, wherein the thermoplastic polymer composition comprises a polymer selected from the group consisting of polycarbonate, polyester, polyamide, and combinations thereof.

4. The laser-weldable composition of claim 1, wherein the thermoplastic polymer is a selected from the group consisting of poly(butylene terephthalate), poly(ethylene terephthalate), and combinations thereof.

5. The laser-weldable composition of claim 1, wherein the thermoplastic polymer composition comprises a combination of a polycarbonate and a polyester.

6. The laser-weldable composition of claim 1, wherein the thermoplastic polymer composition comprises from 10 to 90 weight percent of a polycarbonate, from 10 to 90 weight percent of a polyester, and from 0 to 40 weight percent of an impact modifier, each based on the total weight of the thermoplastic polymer composition.

7. The laser-weldable composition of claim 1, wherein the thermoplastic polymer composition further comprises an impact modifier, wherein the impact modifier is a natural rubber, low-density polyethylene, high-density polyethylene, polypropylene, polystyrene, polybutadiene, styrene-butadiene, styrene-butadiene-styrene, styrene-ethylene-butadiene-styrene, acrylonitrile-butadiene-styrene, acrylonitrile-ethylene-propylene-diene-styrene, styrene-isoprene-styrene, methyl methacrylate-butadiene-styrene, a styrene-acrylonitrile, an ethylene-propylene copolymer, an ethylene-propylene-diene terpolymer, an ethylene-methyl acrylate copolymer, an ethylene-ethyl acrylate copolymer, an ethylene-vinyl acetate copolymer, an ethylene-glycidyl methacrylate copolymer, a polyethylene terephthalate-poly(tetramethyleneoxide)glycol block copolymer, a polyethylene terephthalate/isophthalate-poly(tetramethyleneoxide)glycol block copolymer, a silicone rubber, or a combination comprising at least one of the foregoing impact modifiers.

8. The laser-weldable composition of claim 1, wherein the thermoplastic polymer composition comprises from 40 to 60 weight percent of the polycarbonate, from 40 to 60 weight percent of the polyester, and from 1 to 20 weight percent of the impact modifier, and further wherein the polycarbonate comprises units derived from bisphenol A, the polyester is poly(butylene terephthalate), and the impact modifier is a core-shell polymer.

9. The laser-weldable composition of claim 1 wherein the near-infrared material is selected from the group consisting of polycyclic organic compounds, perylenes, metal-oxides, mixed metal-oxides, metal-complexes, metal-sulphides, metal-borides, metal-phosphates, metal-carbonates, metal-sulphates, metal-nitrides, lanthanum hexaboride, cesium tungsten oxide, indium tin oxide, antimony tin oxide, indium zinc oxide, and combinations thereof.

10. The laser-weldable composition of claim 1, wherein the near-infrared material is selected from the group consisting of lanthanum hexaboride, cesium tungsten oxide, and a combination thereof.

11. The laser-weldable composition of claim 1 wherein the near-infrared material has an average particle size of 1 to 200 nanometers.

12. The laser-weldable composition of claim 1, comprising 0.1 to 15 weight percent of the white pigment, based on the total weight of the laser-weldable composition.

13. The laser-weldable composition of claim 1 wherein the white pigment has an average particle size from 0.01 to 10 micrometers.

14. The laser-weldable composition of claim 1, wherein the white pigment is selected from the group consisting of a particulate titanium dioxide pigment, a particulate zinc sulfide pigment, and a combination thereof.

15. The laser-weldable composition of claim 14 wherein the composition consists essentially of no white pigments other than the titanium dioxide, the zinc oxide, or a combination thereof.

16. The laser-weldable composition of claim 1 wherein the composition contains no barium sulfate, mica, talc, or carbon black.

17. The laser-weldable composition of claim 1, comprising, based on the total weight of the laser-weldable composition,
from 75 to 99.5 weight percent of the thermoplastic polymer composition, wherein the thermoplastic polymer composition comprises a polycarbonate, a polyester, or a combination thereof;
from 0.0001 to 1 weight percent of the near-infrared material; and
from 0.5 to 5 weight percent of the white pigment, wherein the white pigment is selected from particulate titanium dioxide, zinc sulfide, and a combination thereof, each wherein the laser-weldable composition comprises no other white pigment.

18. The laser-weldable composition of claim 1 comprising, based on the total weight of the laser-weldable composition,
from 75 to 99.5 weight percent of the thermoplastic polymer composition, wherein the thermoplastic polymer composition comprises a polycarbonate having units derived from bisphenol A, a poly(butylene terephthalate), and a methacrylate-styrene-butadiene impact modifier;
from 0.0001 to 0.5 weight percent of the near-infrared material, wherein the near-infrared material comprises lanthanum hexaboride, cesium tungsten oxide, or a combination thereof; and
from 0.5 to 5 weight percent of the white pigment, wherein the white pigment is selected from particulate titanium dioxide, zinc sulfide, and a combination thereof, each wherein the laser-weldable composition comprises no other white pigment.

19. A method of manufacturing a laser-weldable composition, comprising melt blending the components of claim 1 to form the laser-weldable composition.

20. An article comprising the laser-weldable composition of claim 1.

21. A method of manufacture of an article, comprising forming, extruding, casting, or molding a melt of the laser-weldable composition of claim 1.

22. A laser-welded article comprising
a first laser-weldable thermoplastic component that is at least partially transmissive to near-infrared radiation wavelengths, and
a second laser-weldable component comprising the composition of claim 1, wherein at least a portion of a surface of the first laser-weldable thermoplastic component is laser-welded to at least a portion of a surface of the second laser-weldable component.

23. The laser-welded article of claim 20, wherein a tensile shear strength between the first thermoplastic component and the second laser-weldable component ranges from 10 N/mm² to 50 N/mm², determined in accordance with a tensile shear test at a speed of 5 mm/minute.

24. The laser-welded article of claim 22, wherein the second laser-weldable component comprises:
from 75 to 99 weight percent of the thermoplastic polymer composition, wherein the thermoplastic polymer composition comprises a polycarbonate having units derived from bisphenol A, a poly(butylene terephthalate), and a methacrylate-styrene-butadiene impact modifier;
from 0.0001 to 1 weight percent of the near-infrared material, wherein the near-infrared material is lanthanum hexaboride, cesium tungsten oxide, or a combination thereof; and
from 0.5 to 5 weight percent of the white pigment, wherein the white pigment is a titanium dioxide pigment, and wherein the second laser-weldable component comprises no other white pigment; and,
wherein the tensile shear strength between the first thermoplastic component and the second laser-weldable component is greater than 15 N/mm², determined in accordance with tensile shear test at a speed of 5 mm/minute.

25. A method of laser-welding thermoplastic components, comprising:
contacting at least a portion of a surface of a first laser-weldable thermoplastic component that is transmissive to near-infrared radiation wavelengths, with at least a portion of a surface of a second laser-weldable thermoplastic component comprising the laser-weldable composition of claim 1;
irradiating with a near-infrared laser through the first thermoplastic component to the second thermoplastic laser-weldable component with an intensity of radiation effective to welding the first thermoplastic laser-weldable component to the second thermoplastic laser-weldable component.
